(19) United States
(12) Patent Application Publication
(10) Pub. No.: US 2020/0311787 A1
(43) Pub. Date: Oct. 1, 2020

(54) SYSTEM AND METHOD FOR PROVIDING UPDATED OFFERS

(71) Applicant: Squeeze, LLC, Boca Raton, FL (US)

(72) Inventor: Elias Janetis, Boca Raton, FL (US)

(21) Appl. No.: 16/825,275

(22) Filed: Mar. 20, 2020

Related U.S. Application Data
(60) Provisional application No. 62/825,210, filed on Mar. 28, 2019.

(51) Int. Cl. G06Q 30/06; G06Q 20/12; G06Q 40/08; G06Q 30/02; G06Q 20/38; G06F 9/54

(52) U.S. Cl. CPC G06Q 30/0605; G06Q 20/127; G06Q 30/0631; G06F 9/542; G06Q 30/0205; G06Q 30/0611; G06Q 20/383; G06Q 40/08

(57) ABSTRACT

A system for updating offers includes a computer for receiving consumer data. A data entry application removes pertinent data from the consumer data as a function of a type of products being offered. An application program interface maps the pertinent data to products as determined by the appropriateness of the pertinent data for a respective product. A clock stores a time period for which the consumer requires a renewal of the product and determines when such time period elapses and outputs a signal to the application program interface before the time period has elapsed. The application program interface forwards the pertinent data to two or more vendors in response to the clock signal; the two or more vendors chosen as a function of the mapping of the stored pertinent data to products offered by the vendor, and receives product offers corresponding to the pertinent data. The application program interface forwards the received product offers to the computer for display to the consumer as product offerings.

### CROSS REFERENCE TO RELATED APPLICATION

This application claims priority to U.S. Provisional Application No. 62/825,210 filed Mar. 28, 2019, the contents of which are herein incorporated.

### FIELD OF INVENTION

The invention disclosed herein relates generally to a system and method for enabling on line comparison shopping, and more specifically to a system and method of operation which pushes pertinent comparisons of offers to a consumer rather than requiring the consumer to pull data and offers from a variety of sources each time a consumer wishes to compare offerings made online.

### BACKGROUND OF THE INVENTION

Comparison shopping is a time honored methodology for ensuring that a consumer obtains an optimized deal for their needs based on their situation. However, even with the advent of the Internet and online shopping services, the process takes time and effort and doesn't always get the best results. As is currently known in the prior art, the consumer must actively search for items of interest. Often the best deals are missed through a lack of knowledge, or because of the flood of online information, the need for the consumer to find the proverbial “needle” in the haystack of webpages and online offers.

To overcome the above shortcomings, subject matter comparison-shopping sites such as Priceline.com; trivago.com; hotel.com and the like are known in the art. At these sites, the consumer enters information, the type of travel item they are interested in purchasing, and a number of choices from which to comparison shop are provided. These types of services have been satisfactory however they require the repetitive filling in of information data each time a new travel item is sought, and the consumer's data is often used by the potential service provider (whether a deal is consummated or not) or sold; generating spam from the product vendors or lead generation companies. Even with these offer comparison type sites, the consumer must still weed through a number of sites in order to obtain their desired result. The consumer must still actively pull information from the web each time they wish to compare product offerings. Thus to receive updated offers, the consumer must return to the site and begin again.

Lastly, such a system does not lend itself to comparison shopping for services, such as insurance, mortgages, or the like which are either renewal-based or reviewed over time for changes in product line. Because of the intricacies of criteria matching, some experts consider products such as insurance to be inapplicable for online sales as a result of the prior art method. See Nicole Friedman, Want to Shop for Car Insurance Online? Prepare for a Bumpy Ride; The Wall Street Journal; WSJ.com

Accordingly a system which overcomes the shortcomings of the prior art by removing the need for the consumer to pull data from the internet, while protecting the consumer from unwanted offers is desired.

### SUMMARY OF THE INVENTION

A system includes a computer which enables consumers to enter data. An application program interface (API) in communication with the computer receives the data and removes pertinent data as a function of the types of products and services being ordered and stores the pertinent data in a database as a function of associated data mapped to products or services as determined by the appropriateness of the pertinent data for that product or service. A clock is in communication with the API. The clock stores a time period for which the user requires a renewal or update of a service or product and determines when such time period elapses and outputs a clock signal to the API before the period has elapsed. The API forwards the pertinent information to product and service providers, in response to the clock signal, and receives product and service proposals corresponding to the pertinent data. The API forwards the received product and service proposals to the computer for display to the consumer as product and service offerings.

In another embodiment of the invention, the system includes a data analyzer in communication with the database and a second database. The API monitors offers and acceptance of offered products and services and stores the identity of the products and services which have been accepted in the database. The data analyzer receives such data and determines acceptance trends as a function of pricing and any one of, or all of, past product purchases, geography, income, asset value, and the like. The data analyzer outputs the trend lines to the API. The API utilizes the trend lines to determine the number of past offers made by each product offeror which were transmitted to the consumer at the computer, and the API adjusts the proposals to equally distribute future consumer proposals presented at the computer to the consumer.

In yet another embodiment, minimal mandatory criteria for each consumer for a desired product or service is stored in the database. An authorization, from the consumer, for selecting a particular product or service which provides the mandatory criteria is stored in the database. In response to the clock signal the API provides the products or services corresponding to the pertinent data, including the mandatory criteria, to the data analyzer, the data analyzer determines the low cost service or product containing such mandatory criteria and outputs the selection to the API, the API purchasing, pursuant to the authorization, the selected low cost product or service meeting the mandatory criteria on behalf of the consumer.

### BRIEF DESCRIPTION OF THE DRAWINGS

The present disclosure is better understood by reading the written description with reference to the accompanying drawings and figures in which like reference numerals denote similar structure and refer to the elements throughout, in which:

FIG. 1 is a schematic diagram of a system for providing updated offers in accordance with the invention;

FIG. 2 is a flow chart for operation of the system for providing updated offers in accordance with the invention; and

FIG. 3 is a flowchart for operation of the system to enhance the variety and timeliness of updated offers in accordance with the invention.

### DETAILED DESCRIPTION OF THE PREFERRED EMBODIMENTS

The subject matter of aspects of embodiments of the present invention is described with specificity herein to meet statutory requirements. However, the description itself is not intended to limit the scope of any patent issuing from this description. Rather, the inventor has contemplated that the claimed subject matter might also be embodied in other ways, to include different elements or combinations of elements similar to the ones described in this document, in conjunction with other present or future technologies.

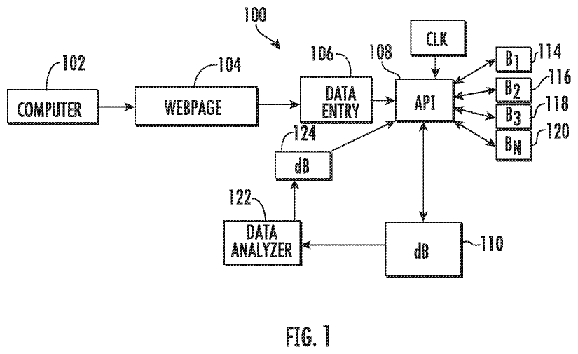

Reference is made to FIG. 1 in which a system, generally indicated as 100, for providing updated offers is provided. A computer 102 communicates through a webpage portal 104 with a data entry application 106. The structure enables a user to input consumer data at computer 102 which is parsed by data entry application 106 to identify and remove personal data, which may identify the consumer to the selected vendors, and retain the pertinent data, selected as a function of sought products and services. Data entry application 106 determines which data is pertinent as a function of the product or service for which offers will be provided. Data entry application 106 communicates with an API 108. In a preferred nonlimiting embodiment computer 102 is a mobile device such as a smart phone, but it may also be a laptop, personal computer, iPad or notebook type device or the like.

API 108 communicates with a first database 110. While API 108 stores all necessary data, including personal data, in database 110, API 108 maps pertinent information to products and/or services of interest as a function of the relevancy of the pertinent information to a determination of the appropriateness of the product and/or service. Relevancy may in one non limiting embodiment of an insurance product be a function of the existence of current coverage or not, geographic location (screening out certain providers, representing a high risk area for flood or hurricane). More specifically relevancy may incorporate driving record for vehicle insurance, renter or owner for home insurance, etc.

API 108 stores the pertinent data as mapped in a first database 110. It should be noted that a portion of the functionality of data entry application 106, in particular determining which data is pertinent as a function of the product, may also be performed by API 108.

API 108 also communicates with a plurality of product providers (vendors) B₁-B_{N} (providers 114-120). Vendors 114-120 provide offers for products and services as a function of received pertinent data. For example, if offering property insurance the pertinent data may be the age and geographical location of the property being insured as well as the value of the property being insured. Vendors 114-120 correspond to the online presence of insurance providers in this nonlimiting example.

A clock 112, in communication with API 108, counts elapsed time. Clock 112 also stores one or more predetermined time intervals corresponding to a time period at the end of which a product must be renewed or replaced. Clock 112 continuously compares the counted elapsed time to a stored predetermined time interval and determines when a predetermined time interval has elapsed and outputs a clock signal in response thereto. In a nonlimiting exemplary insurance example, ahead of the end of each one year anniversary, when an insurance policy is usually due to be renewed, clock 112 outputs a clock signal to the API 108 when the policy term is due to elapse indicating that a replacement policy may be required.

It should be noted that in a simplified embodiment, clock 112 merely provides an elapsed time count, and the functionality of determining the end of the predetermined time interval can be determined by API 108 as a function of time intervals stored in database 110. By comparing the count as output by clock 112 and the interval as stored in database 110, API 108 can determine when a predetermined time interval has elapsed. This use of clock 112 makes it applicable to other functionality as described below.

Database 110 is in communication with API 108 and computer 102. As API 108 receives product/service proposals, they are stored in database 110. Once API 108 determines that a sufficient number of proposals have been stored in database 110 for a meaningful comparison, API 108 causes database 110 to push product/service proposals stored in database 110 to computer 102 for consideration by the consumer at a time when renewal decisions must be made.

In another embodiment of the invention, acceptance of offers are input at computer 102 and transmitted to product vendors 114-120 by API 108. The accepted offer, and offer terms, are stored by API 108 at database 110. A data analyzer 122, such as Google® Big Query, in a preferred nonlimiting embodiment, is in communication with database 110 and a second database 124. Second database 124 is in communication with API 108. Data analyzer 122 receives the offers provided to computer 102 as well as the acceptance of the selected offer. Data analyzer 122 determines acceptance trends as a function of pricing and at least any one (or all) of a number of additional factors such as past offers accepted by a particular consumer, geographic location of the item insured, geographic location of the consumer, income, asset value or the like. Data analyzer 122 determines trend lines from this data and stores the trend lines in second database 124. API 108 may utilize these trend lines, in one non limiting embodiment, to ensure that the offers are equally distributed among different consumer options; different product or service providers; i.e. not all from different brokers for the same provider such as the same insurance company; which in effect is the same product offered several times simultaneously.

It becomes readily apparent, that system 100 communicates with providers 114-120 over a distributed network such as the World Wide Web; the cloud. Additionally, the consumer communicates from their computer 102 with web page 104 and in turn API 108 over the World Wide Web; the cloud. However, applicant notes that the remainder of system 100 may be located at a single local location, or may be part of a distributed network in communication with each other and disposed within the cloud. Lastly it should be noted that any mechanism that transmits information about the consumer from computer 104 to API 108 is within the contemplated scope of the invention.

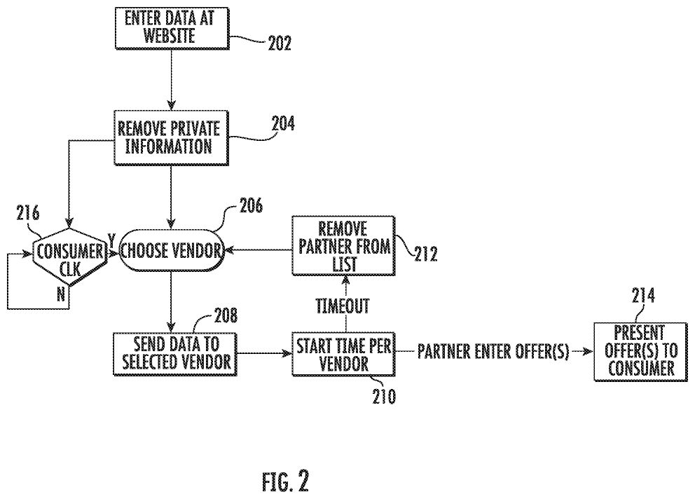

Reference is now made to FIG. 2 in which a method of operation of system 100 in accordance with the invention is provided. In a step 202 a consumer, from computer 102, enters consumer data at a webpage 104 of a website. In a step 204 pertinent data is removed from the consumer data as input by the data entry application 106; particularly personal and private information capable of identifying the consumer is removed from the consumer data leaving pertinent data. Pertinent data may be further determined as a function of the data entered and the product or service for which the operation is to be performed. Therefore the culled pertinent data can change over time.

In a step 206, API 108 determines whether pertinent data for a particular consumer matches criteria for the offered product of each vendor, and selects the appropriate vendor, if any, based on matching the pertinent data and criteria at a predetermined threshold level indicative of the proposals being the type of interest to the consumer. The threshold may be merchant driven to screen for acceptable viable candidates and may include credit score thresholds, geographic location radius, or the like. API 108 transmits the pertinent consumer data in a step 208 as a function of the desired products or service to the various service/product vendors 114-120 meeting the criteria matching threshold.

API 108 begins a timeout count in a step 210 as a function of the transmission of the data to a respective vendor 114-120. A timeout count is begun for each respective vendor 114-120 as a function of when the data is transmitted to that particular vendor. API 108, based on inputs of clock 112, determines whether a predetermined interval of time has expired from the offer request transmission. If API 108 determines that no offer has arrived from a particular vendor before expiration of the time interval for that vendor, then API 108 removes the vendor from the list of potential sources for this offer. Offers received before expiration of the time period for each respective vendor are transmitted to the consumer at computer 102 as an updated proposal in a step 214. In this way computing resources are not wasted on offers which may not materialize, other offers are given an opportunity to be presented, and the process of sending the offers to the consumer is not unduly delayed.

In one embodiment, as information is parsed in step 204 by data entry application 106, information regarding renewal dates for services such as insurance, cell phone service, cable service and the like is transmitted to either one of clock 112 or API 108. As discussed above, a predetermined time interval until the renewal of such service is determined and clock 112 counts down the expiration of the renewal date in a step 216. In step 216 if it is determined that the time interval is about to expire, then the process moves to a step 206 in which potential replacement vendors with updated offers are solicited for proposals as discussed above. If the time interval has not ended then the count continues and the process returns to step 216. In the preferred embodiment, the time interval which is counted is such time period which is less than the expiration date such as one month, ten days or the like to provide the user meaningful time to compare received proposals with their current service contract. However the date cannot be so great that the proposal cannot reasonably expire as they are often time sensitive.

It is also beneficial to the consumer to receive a variety of quotes in a timely fashion to make an educated choice with respect to updated offers. It also keeps vendors' offers competitive by forcing them to provide offers that will be accepted compared to other vendors. In the preferred nonlimiting example system 100 provides five offers. Furthermore, offers must be screened for appropriateness. This is often a function of geography, budget, offer source (same insurer, many brokers) or the like. Accordingly, in the preferred nonlimiting embodiment, in step 206 appropriate vendors are not only selected, but provided in a manner to optimize the presentation of updated offers to the consumer at computer 102.

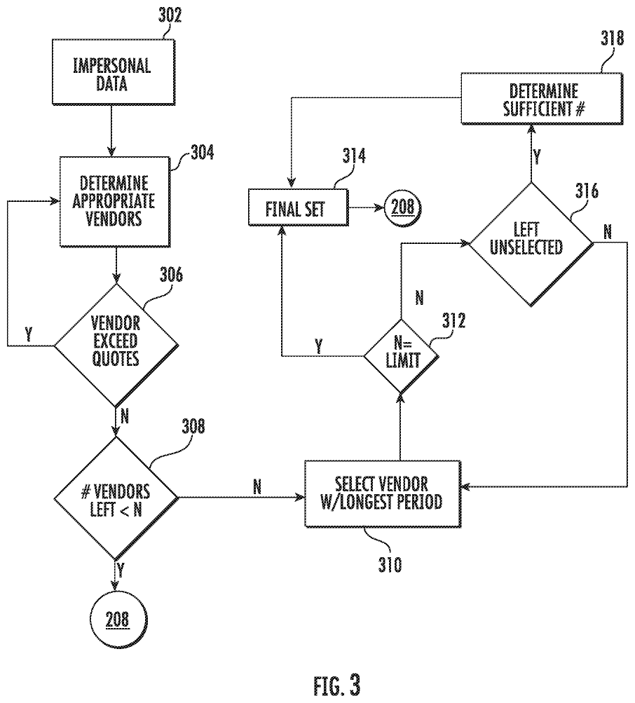

Reference is now made to FIG. 3 in which the operation of step 206 for selecting offers to be presented to a consumer is provided with greater detail. In a step 302 API 108 considers the impersonal data already stored in database 110. Utilizing the vendor information either stored in database 110 or received directly from vendors 114-120, API 108 determines the appropriateness of each vendor as a function of the impersonal data and the vendor data in a step 304. API 108 filters the vendors by any one or more or all of geographical proximity to the customer in question, whether the vendor is licensed in the state of the customer so that it may offer services such as insurance or banking, the income of the customer, the value of property to be insured, or even to prevent the same carrier being chosen through a variety of brokers (this is variety of broker, not product), or any other factor which may make an offered service inappropriate for a customer.

To ensure fairness in the system and that a single vendor does not monopolize the offer system, in a step 306 it is determined whether the selected vendor has exceeded a permitted number of offers made during a predetermined time period; fifteen offers in a single day by way of nonlimiting example. If the limit has been exceeded then the process returns to step 304 and a different vendor is provided. In other words the process stops for that vendor for this search of offers.

It is also desirable to prevent the consumer from being overwhelmed by a flood of offers even if from a variety of different vendors; this would be no different then the SPAM of current systems. Therefore, if the vendor has not exceeded its permissible allotted quoted offers in step 306, in a step 308 it is determined whether the number of vendors is greater than or equal to a determined limit on the number of vendors. In our non-limiting example, the system promotes providing five offers from five different vendors. However other numbers may be used. API 108 counts the number of vendors it has selected through step 306. In our example if the number of available vendors is less than five the process moves to step 208 to provide the data to the available vendors as no more vendors are available.

If in step 308 it is determined that the number of desired vendors has been exceeded, then in step 310, the vendor having the longest period since the last offer from that vendor is selected to be presented to the consumer. In this way, the process is fair to each vendor and promotes variety of vendors and offers. In a step 312 it is determined whether the number of vendors is equal to the predetermined limit of vendors, each vendor preferably providing one offer; five in the non limiting example. If the number is equal to five then in a step 314 the final set is created and the process moves to step 208. If the number has not been exceeded then the process proceeds to a step 316 where a determination is made to complete the vendor set.

In step 316 it is determined by API 108 how many vendors are remaining to be selected. If the number of vendors available for selection is greater than or equal to one the process returns to step 310. However if there are no remaining vendors and the total number of vendors is less than the desired five offers, it is determined by API 108 whether there are a sufficient number of vendors in step 318. If for example three or more vendors are acceptable as providing a sufficient number of updated offers then the final set of offers is made in a step 314 and the process returns to step 208. It should be noted that the number of sufficient vendors may be as low as one or as high as four. However in this way, the system can ensure that a meaningful number of offers is provided to the customer in step 208.

As a result of receiving consumer data from the consumers, then removing the personal information from that data, and storing that data for repetitive use, and transmitting that data to two or more potential vendors of proposals for goods or services, comparison-shopping for optimized terms and conditions can be provided to a consumer, with little consumer effort, without putting the consumer at risk of unwanted offers, spam, or loss of privacy through the sale of consumer information. Furthermore, by providing a clock to cause the offers to be sought either on a periodic basis, or in a timely manner upon the need for renewal of a product or service, product options are automatically updated and provided to the consumer without the need for the consumer to spend time and effort searching through the morass of online vendors, or the need to continuously reenter both personal and pertinent data for their use.

By counting and tracking the number of all offers made by each vendor and clocking the time period for accepted offers, system 100 can ensure a variety of offers and opportunities for both the consumer and the vendor.

The foregoing description is considered as illustrative only of the principles of the invention. Further, since numerous modifications and changes will be readily apparent to those skilled in the art, it is not desired to limit the invention to the exact construction and process shown as described above. Accordingly, all suitable modifications and equivalents may be resorted to falling within the scope of the invention as defined by the claims that follow.

What is claimed is:

1. A system for updating offers comprises:
a computer for receiving consumer data input by a consumer;
a data entry application in communication with the computer for receiving the consumer data and removing pertinent data from the consumer data as a function of a type of products and services being offered;
a database for storing the pertinent data,
an application program interface in communication with the database, the application program interface mapping the pertinent data to products or services as determined by the appropriateness of the pertinent data for a respective product or service and storing the mapping of pertinent data in the database;
a clock in communication with the application program interface, the clock storing a time period for which the consumer requires at least one of a renewal or update of a respective product or service, and determines when such time period elapses, the clock outputting a signal to the application program interface before the time period has elapsed; the application program interface forwarding the pertinent data to two or more vendors in response to the clock signal, the two or more vendors being chosen as a function of the mapping of the stored pertinent data to products or services offered by the vendor, the application program interface receiving product or service offers corresponding to the pertinent data from one or more of the two or more vendors; and the application program interface forwarding the received product or service offers to the computer for display to the consumer as product offerings.

2. The system of claim 1, wherein the application program interface determines the appropriateness of the pertinent data for a respective product or service as a function of relevancy of the pertinent data to the product or service.

3. The system of claim 1, wherein the relevancy is a function of at least one of a geographic location of the consumer, a status of current insurance coverage for the consumer, and a driving record of the consumer.

4. The system of claim 1, wherein the application program interface counts a number of product or service offers received, and not causing the offers to be forwarded until a predetermined number of offers has been received.

5. The system of claim 1, further comprising a data analyzer in communication with the database, the computer transmitting an acceptance of an offer to a selected vendor, the application program interface receiving the acceptance and storing acceptance data in the database, the data analyzer receiving the acceptance data and each offer, and determining acceptance trends as a function of pricing and at least one of past accepted offers, geographic location of the consumer, consumer income, and asset value of the consumer.

6. The system of claim 5, wherein the application program interface receives the acceptance trends and determines which of the two or more vendors are enabled to make offers as a function of said acceptance trends.

7. The system of claim 1, wherein the application program interface receives a clock input from said clock, determines when the pertinent data is forwarded to each respective one of the two or more vendors and begins a time out clock for each vendor in response to such determination.

8. The system of claim 7, wherein the application program interface determines that the time out clock has elapsed for a respective vendor, and if no offer has been received from the respective vendor, preventing transmission of an offer received from said vendor to the computer.

9. The system of claim 1, wherein the application program interface counts the number offers received from a single vendor, and prevents transmission of an additional offer from said single vendor to the computer when the number of offers from the single vendor exceeds a predetermined number.

10. The system of claim 1, wherein the application program interface counts the number offers received from the two or more vendors and prevents additional offers from being transmitted to the computer when the total number of offers exceeds a predetermined number.

11. The system of claim 1, wherein the computer is a mobile device.

12. The system of claim 1, further comprising a webpage portal in communication with the computer and the data entry application and the webpage enabling the computer to receive consumer data.

13. The system of claim 1, wherein the pertinent data does not include data capable of identifying the consumer.

14. A method for updating offers comprises:
receiving consumer data at a computer;
removing pertinent data from the consumer data with a data entry application, as a function of a type of product or service being offered;
mapping the pertinent data with an application program interface to products or services as determined by the appropriateness of the pertinent data for a respective product or service and storing the mapping of the pertinent data;
forwarding the pertinent data with the application program interface to two or more vendors in response to a determination that a time period is about to expire, the two or more vendors being chosen as a function of the mapping of the stored pertinent data to products or services offered by the vendor,
receiving product at the application program interface offers corresponding to the pertinent data; and
forwarding the received product offers to the computer for display to the consumer as product offerings.

15. The method of claim 14, further comprising the step of:
counting a number of product or service offers received, and not causing the offers to be forwarded to the computer until a predetermined number of offers has been received.

16. The method of claim 14, further comprising the steps of:
transmitting an acceptance of an offer to a selected vendor from the computer; receiving acceptance data about the acceptance of each offer at a data analyzer, and determining acceptance trends as a function of pricing and at least one of past accepted offers, geographic location, consumer income, and asset value.

17. The method of claim 14, further comprising the steps of:
receiving a clock input from a clock; determining when the pertinent data is forwarded to each respective one of the two or more vendors and beginning a time out clock with the application program interface for each vendor in response to such determination; determining that the time out clock has elapsed for a respective vendor, and if no offer has been received from the respective vendor, the application program interface prevents transmission of the offer from the respective vendor to the computer.

18. The method of claim 14, further comprising the steps of:
counting the number offers received by a single vendor with the application program interface, and preventing transmission of an additional offer from single vendor to the computer when the number of offers from the single vendor exceeds a predetermined number.
